(19) United States
(12) Patent Application Publication
(10) Pub. No.: US 2026/0188109 A1
(43) Pub. Date: Jul. 2, 2026

(54) VEHICLE TRAFFIC FLOW PREDICTION METHOD WITH MISSING DATA

(71) Applicant: Xidian University, Xi'an (CN)

(72) Inventors: Changle Li, Xi'an (CN); Wenwei Yue, Xi'an (CN); Hehe Zhang, Xi'an (CN); Yue Chen, Xi'an (CN)

(21) Appl. No.: 19/008,591

(22) Filed: Jan. 2, 2025

(51) Int. Cl. G08G 1/01

(52) U.S. Cl. CPC G08G 1/0133

(57) ABSTRACT

A vehicle traffic flow prediction method with missing data is disclosed. The method includes the steps of inputting the topological structure of the traffic flow to be predicted, selecting a certain road section in the road network as the road section to be predicted, and determining the adjacent road section data set of the road section to be predicted by the spatial-temporal relationship between the observable data and the missing data. According to the nearest neighbor algorithm, the missing data in the data set of the adjacent road sections are filled to get the filled data set, and then the traffic flow data of the road sections to be predicted at the prediction time is obtained. The method can be used for efficiently predicting the vehicle traffic flow of a certain road section in the case of missing traffic flow data in the complex urban road network.

### TECHNICAL FIELD

The present application relates to the field of physical technology, and further relates to a traffic flow prediction method based on optimal segmentation in the case of missing data in the field of traffic flow prediction technology. The present application can use the optimal segmentation method to predict the urban road traffic flow in the future preset time period under the condition of missing traffic data, which can be used to provide real-time traffic flow changes for vehicles under the condition of missing data, and can provide real-time reference basis for travelers and traffic management departments.

### BACKGROUND

Traffic flow prediction is to predict the real-time flow of vehicles on urban roads. As the basis of real-time traffic state discrimination and traffic flow guidance, it is playing an increasingly important role. On the one hand, traffic flow prediction information can provide travelers with the planning basis of travel mode, route and time, so as to improve travel efficiency and reduce travel cost. On the other hand, the traffic flow prediction information can also provide real-time decision-making basis for the traffic management department, through the development of appropriate traffic control strategies to alleviate traffic congestion and improve the traffic environment. The key of traffic flow prediction lies in the collection and storage of complete traffic flow data. However, in the complex urban road environment, the failure of detector and storage device, loss of communication system, meteorological status and other factors will inevitably lead to the loss of traffic flow data, which seriously affects the effectiveness of traffic flow prediction. Therefore, it is necessary to deal with the missing data effectively to make the observation data set complete and provide efficient and accurate traffic flow prediction. Usually, there are two traditional traffic flow prediction methods: one is to directly use incomplete traffic flow data for traffic flow prediction, which increases the difficulty of prediction and reduces the accuracy of prediction; The other is to fill in all the missing data, and then predict the traffic flow based on the complete traffic flow data, which increases the additional cost and delay, and is difficult to meet the demand of traffic management departments and travelers for real-time traffic data.

University of Electronic Science and Technology proposed a traffic flow prediction method based on deep neural network model in its patent document “A Short-Term Traffic Flow Prediction Method Combined With Spatiotemporal Characteristics” (Application No.: 201910940885, Publication No.: CN110782663A). This method is based on massive traffic data, reduces the complexity of prediction model through neural network, and saves prediction time to predict real-time traffic flow more efficiently and quickly. The disadvantage of this method is that the method does not take into account that the historical traffic flow data obtained is a data set with a large probability of missing data. If an incomplete data set is used to predict, the difficulty of prediction will increase, and the accuracy of the prediction result will decrease.

Sehyun Tak et al. proposed a traffic flow prediction method based on interpolation method in the paper “Data-Driven Imputation Method for Traffic Data in Sectional Units of Road Links” (IEEE Transactions on Intelligent Transportation Systems, Vol. 17, No. 6, June 2016). The feature of this method is to use the time-adjacent data and mode-adjacent data to interpolate and fill in the missing data, get a complete traffic flow data set, and then use the traffic flow prediction model to predict the short-term traffic flow in the road network. The disadvantage of this method is that because this method uses time-adjacent data and mode-adjacent data to interpolate and fill missing data, it fails to comprehensively consider the spatiotemporal relationship between the observed data and the missing data. To fill all the missing data, when the data loss is large in complex urban environment, it will cause additional filling cost, which will lead to the increase of traffic flow prediction delay.

Peibo Duan et al. proposed a traffic flow prediction method by data filling based on statistical learning in their paper “A Unified Spatio-Temporal Model for Short-Term Traffic Flow Prediction” (IEEE Transactions on Intelligent Transportation Systems, Vol. 20, No. 9, September 2019). Based on the statistical characteristics of the observed data, the method fills the missing data through continuous iteration to get a complete data set, and then uses the traffic flow prediction model to predict the short-term traffic flow of the road network. The disadvantage of this method is that because it is based on the statistical characteristics of observation data, it fills the missing data through continuous iteration, which increases the difficulty and delay of prediction; at the same time, this method fills all the missing data, resulting in additional costs and delay problems, which is difficult to meet the needs of traffic management departments and travelers for real-time traffic information.

### SUMMARY

The object of the present application is to provide a vehicle traffic flow prediction method with missing data in order to solve the problem that the road traffic flow cannot be predicted efficiently due to missing traffic flow data in urban traffic.

The idea of realizing the object of the present application is that, due to the storage device, communication system, weather and other factors in the complex urban road environment, the traffic flow data may be missing. Through the optimal segmentation method, comprehensively considering the spatial-temporal relationship between the road to be predicted and the road with missing data, the number of missing data filling in the required data set can be effectively reduced. Then, through the traffic flow prediction model and the obtained complete data set to predict the road traffic flow, it can meet the needs of traffic flow prediction efficiency under the condition of serious data loss in complex traffic environment, and provide real-time reference for travelers and traffic management departments.

To achieve the above object, the specific steps of the present application are as follows:
(1) inputting an urban road network topological structure of a traffic flow to be predicted, and numbering each road section in the urban road network;
(2) using the optimal segmentation method of spatial-temporal relationship to generate adjacent road section data set;
(2a) setting a set for a road section to be predicted, and initializing the set to zero;
(2b) determining whether traffic flow data of all first-order adjacent road sections of the road section to be predicted at the k₁ sampling point before prediction time is complete, if so, adding the corresponding number of each first-order adjacent road section and the traffic flow data at the corresponding time to the set, and then executing step (2f); otherwise, executing step (2c); wherein k₁ represents an average travel time of vehicles from the road section to be predicted to all the first-order adjacent road sections adjacent to the road section to be predicted;
(2c) finding the road sections with complete traffic flow data at the k₁ sampling points before the prediction time from all the first-order adjacent road sections, adding the corresponding number of each first-order adjacent road section and the traffic flow data at the corresponding time into the set;
(2d) determining whether the traffic flow data of all the second-order adjacent road sections connected to each first-order adjacent road section with missing data is complete at the k₂ sampling point before the prediction time, if so, adding the corresponding number of each second-order adjacent road section and the traffic flow data at the corresponding time to the set, and then executing step (2f); otherwise, executing step (2e); wherein k₂ represents an average travel time of vehicles from the road section to be predicted to all the second-order adjacent road sections adjacent to the road section to be predicted;
(2e) finding out the road section with complete traffic flow data at the k₂ sampling point before the prediction time from all the second-order adjacent road sections, adding the corresponding number of each second-order adjacent road section and the traffic flow data at the corresponding time into the set, and adding each road section number corresponding to all third-order adjacent road sections connected to the second-order adjacent road sections with missing data to the set, after then executing step 2f;
(2f) obtaining the data set of the adjacent road sections of the road section to be predicted;
(3) filling in the data set of the adjacent road sections;
through the nearest neighbor algorithm, filling the missing traffic flow data into the data set of the adjacent road sections, so as to obtain the filled data set;
(4) According to the following formula, calculating the cross-correlation coefficient of traffic flow between the road section to be predicted and each road section in the filled data set, respectively:

$${w}_{mn} = \frac{[ ( {x}_{n} ( t ) - \overline{{x}_{n}} ) ( {x}_{m} ( t + {k}_{mn} ) - \overline{{x}_{m}} ) ]}{{σ}_{{x}_{m}} {σ}_{{x}_{n}}}$$

Wherein, wₘₙ represents the cross-correlation coefficient between the traffic flow of the road section n to be predicted and the mth adjacent road in the filled data set, E represents the operation of calculating the expected value, xₙ (t) and xₘ (t+kₘₙ) represent the traffic flow of the road section n to be predicted and the mth adjacent road in the filled data set at the current time t or time t+kₘₙ respectively, kₘₙ represents the average travel time of vehicles from the road section n to be predicted to the mth adjacent road section in one year sampling time, x̅ₘ̅ and x̅ₙ̅ represent the average traffic flow of all vehicles of the mth adjacent road section and the road section n to be predicted in one year sampling time, σₓ_{ₘ} and σₓ_{ₙ} represent the standard deviation of traffic flow of the mth adjacent road section and the road section n to be predicted in one year sampling time;
(5) According to the following formula, calculating the traffic flow of the road section to be predicted at the expected time:

$${X}_{n} ( t ) = {\sum }_{l = 1}^{L} {w}_{mn} {x}_{m} ( t - {k}_{mn} )$$

Wherein, Xₙ (t) represents the traffic flow of the road section n to be predicted at the expected time t, L represents the total number of elements in the filled data set, l represents the serial number of elements in the filled data set, the element with serial number l corresponds to the traffic flow data of the mth adjacent road section, Σ represents the summation operation, and xₘ(t−kₘₙ) represents the traffic flow of the mth adjacent road section to be predicted at the expected time t−kₘₙ.

Compared with the prior art, the present application has the following advantages:

Firstly, in the complex urban road environment, the failure of detector and storage equipment, loss of communication system, meteorological status and other factors will inevitably lead to the loss of traffic flow data. The filling of these missing data ensures accurate traffic flow prediction results, and overcomes the problem of high prediction complexity and low prediction accuracy which caused by direct using of the data provided in the traffic flow prediction in the existing technology and defaulting the data is complete. So that the present application can reduce the complexity of prediction and have higher accuracy when predicting traffic flow.

Secondly, because the present application applies the traffic flow prediction method based on optimal segmentation, the relationship between the predicted road and the road with missing data in time dimension and space dimension is comprehensively considered, which effectively reduces the number of missing data filling in the traffic flow data set, and overcomes the problems of filling all missing data in the prior art, which increases the additional workload and expenses. Under the premise of ensuring the accuracy of traffic flow prediction, the present application can effectively reduce the workload of traffic flow prediction, reduce the prediction time, and ensure the efficiency of traffic flow prediction in the case of missing data.

### BRIEF DESCRIPTION OF THE DRAWINGS

FIG. 1 is a flow chart of the present application;

FIG. 2 is a flow chart of the steps of determining the set of adjacent road sections for the road sections to be predicted by using the optimal segmentation method in the present application.

### DETAILED DESCRIPTION OF THE EMBODIMENTS

The present application will be further described in combination with the drawings.

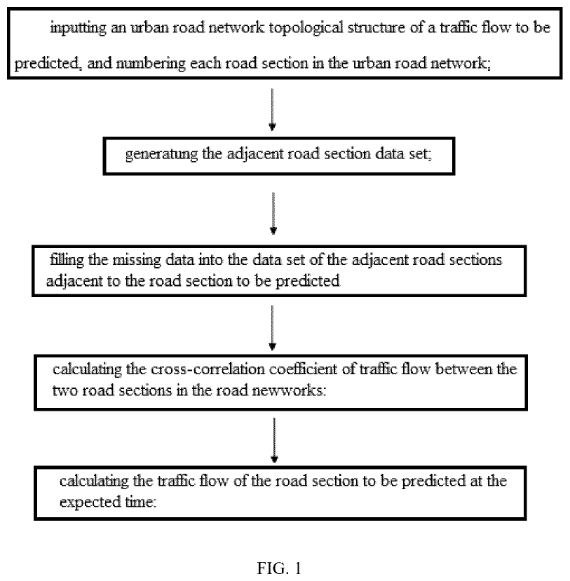

Referring to FIG. 1, the specific implementation steps of the present application are further described.

Step 1, inputting the urban road network topological structure of the traffic flow to be predicted, and numbering each road section in the urban road network.

Step 2, using the optimal segmentation method of spatial-temporal relationship to generate adjacent road section data set.

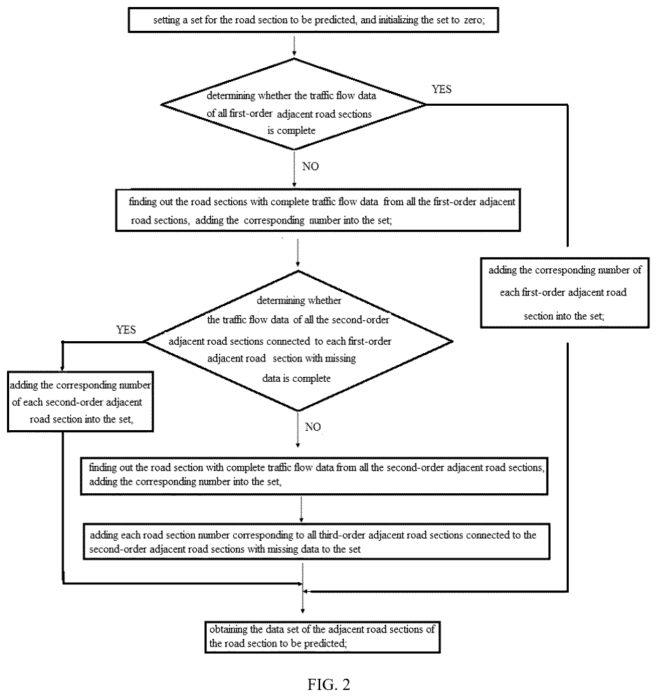

Referring to FIG. 2, it will further describe the specific steps of using the optimal segmentation method to generate the adjacent road section data set of the road section to be predicted.

The first step, setting a set for the road section to be predicted, and initializing the set to zero.

The second step, determining whether the traffic flow data of all first-order adjacent road sections of the road section to be predicted at the k₁ sampling point before prediction time is complete, if so, adding the corresponding number of each first-order adjacent road section and the traffic flow data at the corresponding time to the set, and then executing the sixth step, otherwise, executing the third step. Wherein, k₁ represents an average travel time of vehicles from the road section to be predicted to all the first-order adjacent road sections adjacent to the road section to be predicted.

The third step, finding out the road sections with complete traffic flow data at the k₁ sampling points before the prediction time from all the first-order adjacent road sections, adding the corresponding number of each first-order adjacent road section and the traffic flow data at the corresponding time into the set.

The fourth step, determining whether the traffic flow data of all the second-order adjacent road sections connected to each first-order adjacent road section with missing data is complete at the k₂ sampling point before the prediction time, if so, adding the corresponding number of each second-order adjacent road section and the traffic flow data at the corresponding time to the set, and then executing the sixth step, otherwise, executing the fifth step. Wherein, k₂ represents an average travel time of vehicles from the road section to be predicted to all the second-order adjacent road sections adjacent to the road section to be predicted.

The fifth step, finding out the road section with complete traffic flow data at the k₂ sampling point before the prediction time from all the second-order adjacent road sections, adding the corresponding number of each second-order adjacent road section and the traffic flow data at the corresponding time into the set, and adding each road section number corresponding to all third-order adjacent road sections connected to the second-order adjacent road sections with missing data to the set, after then executing the sixth step.

The sixth step, obtaining the data set of the adjacent road sections of the road section to be predicted.

The first-order adjacent road sections, the second-order adjacent road sections and the third-order adjacent road sections of the road sections to be predicted refer to the first-order adjacent road sections connected with the road sections to be predicted, the second-order adjacent road sections connected with the first-order adjacent road sections and the third-order adjacent road sections connected with the second-order adjacent road sections respectively.

The relationship of “time” in the spatial-temporal relationship refers to the temporal connection between the complete data that can be observed and the data that cannot be observed; The “space” relationship refers to the location relationship between the corresponding sections of the complete data that can be observed and the data that cannot be observed, including the first-order adjacent sections, the second-order adjacent sections and the third-order adjacent sections.

The average travel time is calculated by the following formula:

$${k}_{ij} = ⌈ \frac{{s}_{ij}}{( \overline{{v}_{i}} + \overline{{v}_{j}} ) / 2} ⌉$$

Wherein, kᵢⱼ represents the average travel time of vehicles from road section i to road section j, ┌ ┐ represents to round up operation, sᵢⱼ represents the distance from the center of road section i to the center of road section j, v̅ᵢ̅ and v̅ⱼ̅ respectively represent the average speeds of all vehicles in road section i and road section j in one year sampling time.

Step 3, filling in the data set of the adjacent road sections.

Through the nearest neighbor algorithm, filling the missing traffic flow data into the data set of the adjacent road sections, so as to obtain the filled data set.

The nearest neighbor algorithm is to average the traffic flow data of the two nearest moments from the missing data time in the traffic flow data sampling of a certain road section, the average value is used to fill the traffic flow data of the road section at the missing data time.

The filled data set and the unfilled data set have the same number of elements, and each element corresponds to the same road section. The difference is that all traffic flow data in the filled data set is complete, and traffic flow data of some road sections in the unfilled data set is missing.

Step 4, according to the following formula, calculating the cross-correlation coefficient of traffic flow between the road section to be predicted and each road section in the filled data set, respectively:

$${w}_{mn} = \frac{[ ( {x}_{n} ( t ) - \overline{{x}_{n}} ) ( {x}_{m} ( t + {k}_{mn} ) - \overline{{x}_{m}} ) ]}{{σ}_{{x}_{m}} {σ}_{{x}_{n}}}$$

Wherein, wₘₙ represents the cross-correlation coefficient between the traffic flow of the road section n to be predicted and the mth adjacent road in the filled data set, E represents the operation of calculating the expected value, xₙ (t) and xₘ (t+kₘₙ) represent the traffic flow of the road section n to be predicted and the mth adjacent road in the filled data set at the current time t or time t+kₘₙ respectively, kₘₙ represents the average travel time of vehicles from the road section n to be predicted to the mth adjacent road section in one year sampling time, x̅ₘ̅ and x̅ₙ̅ represent the average traffic flow of all vehicles of the m th adjacent road section and the road section n to be predicted in one year sampling time, σₓ_{ₘ} and σₓ_{ₙ} represent the standard deviation of traffic flow of the m th adjacent road section and the road section n to be predicted in one year sampling time.

Step 5, according to the following formula, calculating the traffic flow of the road section to be predicted at the expected time:

$${X}_{n} ( t ) = {\sum }_{l = 1}^{L} {w}_{mn} {x}_{m} ( t - {k}_{mn} )$$

Wherein, Xₙ (t) represents the traffic flow of the road section n to be predicted at the expected time t, L represents the total number of elements in the filled data set, l represents the serial number of elements in the filled data set, the element with serial number l corresponds to the traffic flow data of the mth adjacent road section, Σ represents the summation operation, and xₘ (t−kₘₙ) represents the traffic flow of the mth adjacent road section to be predicted at the expected time t−kₘₙ.

The traffic flow refers to the traffic flow at a certain time of one year for each road section in the road network, which is sampled every 1 minute, and the total number of vehicles passing through the road section in each sampling time is called the traffic flow at that time.

The above description is only a specific embodiment of the present application and does not constitute any restriction on the application. It is obvious that after understanding the content and principle of the present application, the skilled person in the art is possible to make various modifications and changes in form and details without departing from the principle and structure of the present application. However, these modifications and changes based on the content and principle of the present application are still within the scope of the claims of the present application.

1. A vehicle traffic flow prediction method with missing data, comprising, performing optimal segmentation to determine the missing data to be filled according to the spatial-temporal relationship between observable data and missing data, predicting a traffic flow of a certain road in a preset time period in the future by using the filled data set; and the method further comprising:
(1) inputting an urban road network topological structure of a traffic flow to be predicted, and numbering each road section in the urban road network;
(2) using the optimal segmentation method of spatial-temporal relationship to generate adjacent road section data set;
(2a) setting a set for a road section to be predicted, and initializing the set to zero;
(2b) determining whether traffic flow data of all first-order adjacent road sections of the road section to be predicted at the k₁ sampling point before prediction time is complete, if so, adding the corresponding number of each first-order adjacent road section and the traffic flow data at the corresponding time to the set, and then executing step (2f); otherwise, executing step (2c); wherein k₁ represents an average travel time of vehicles from the road section to be predicted to all the first-order adjacent road sections adjacent to the road section to be predicted;
(2c) finding out the road sections with complete traffic flow data at the k₁ sampling points before the prediction time from all the first-order adjacent road sections, adding the corresponding number of each first-order adjacent road section and the traffic flow data at the corresponding time into the set;
(2d) determining whether the traffic flow data of all the second-order adjacent road sections connected to each first-order adjacent road section with missing data is complete at the k₂ sampling point before the prediction time, if so, adding the corresponding number of each second-order adjacent road section and the traffic flow data at the corresponding time to the set, and then executing step (2f); otherwise, executing step (2e); wherein k₂ represents an average travel time of vehicles from the road section to be predicted to all the second-order adjacent road sections adjacent to the road section to be predicted;
(2e) finding out the road section with complete traffic flow data at the k₂ sampling point before the prediction time from all the second-order adjacent road sections, adding the corresponding number of each second-order adjacent road section and the traffic flow data at the corresponding time into the set, and adding each road section number corresponding to all third-order adjacent road sections connected to the second-order adjacent road sections with missing data to the set, after then executing step 2f;
(2f) obtaining the data set of the adjacent road sections of the road section to be predicted;
(3) filling in the data set of the adjacent road sections;
through the nearest neighbor algorithm, filling the missing traffic flow data into the data set of the adjacent road sections, so as to obtain the filled data set;
(4) according to the following formula, calculating the cross-correlation coefficient of traffic flow between the road section to be predicted and each road section in the filled data set, respectively:
$${w}_{mn} = \frac{[ ( {x}_{n} ( t ) - \overline{{x}_{n}} ) ( {x}_{m} ( t + {k}_{mn} ) - \overline{{x}_{m}} ) ]}{{σ}_{{x}_{m}} {σ}_{{x}_{n}}}$$
wherein, wₘₙ represents the cross-correlation coefficient between the traffic flow of the road section n to be predicted and the mth adjacent road in the filled data set, E represents the operation of calculating the expected value, xₙ(t) and xₘ(t+kₘₙ) represent the traffic flow of the road section n to be predicted and the mth adjacent road in the filled data set at the current time t or time t+kₘₙ respectively, kₘₙ represents the average travel time of vehicles from the road section n to be predicted to the mth adjacent road section in one year sampling time, x̅ₘ̅ and x̅ₙ̅ represent the average traffic flow of all vehicles of the m th adjacent road section and the road section n to be predicted in one year sampling time, σₓ_{ₘ} and σₓ_{ₙ} represent the standard deviation of traffic flow of the mth adjacent road section and the road section n to be predicted in one year sampling time;
(5) according to the following formula, calculating the traffic flow of the road section to be predicted at the expected time:
$${X}_{n} ( t ) = {\sum }_{l = 1}^{L} {w}_{mn} {x}_{m} ( t - {k}_{mn} )$$
wherein, Xₙ (t) represents the traffic flow of the road section n to be predicted at the expected time t, L represents the total number of elements in the filled data set, l represents the serial number of elements in the filled data set, the element with serial number l corresponds to the traffic flow data of the mth adjacent road section, Σ represents the summation operation, and xₘ(t−kₘₙ) represents the traffic flow of the mth adjacent road section to be predicted at the expected time t−kₘₙ.

2. The vehicle traffic flow prediction method with missing data according to claim 1, wherein the average travel time in step (2b) is calculated by the following formula:
$${k}_{ij} = ⌈ \frac{{s}_{ij}}{( \overline{{v}_{i}} + \overline{{v}_{j}} ) / 2} ⌉$$
wherein, kᵢⱼ represents the average travel time of vehicles from road section i to road section j in one year sampling time, ┌ ┐ represents to round up operation, sᵢⱼ represents the distance from the center of road section i to the center of road section j, v̅ᵢ̅ and v̅ⱼ̅ respectively represent the average speeds of all vehicles in road section i and road section j in one year sampling time.

3. The vehicle traffic flow prediction method with missing data according to claim 1, wherein the nearest neighbor algorithm in step (3) is to average the traffic flow data of the two nearest moments from the missing data time in the traffic flow data sampling of a certain road section, the average value is used to fill the traffic flow data of the road section at the missing data time.

4. The vehicle traffic flow prediction method with missing data according to claim 1, wherein the traffic flow in step (5) refers to the traffic flow at a certain time of one year for each road section in the road network, which is sampled every 1 minute, and the total number of vehicles passing through the road section in each sampling time is called the traffic flow at that time.
